(19) United States
(12) Patent Application Publication
(10) Pub. No.: US 2010/0313890 A1
(43) Pub. Date: Dec. 16, 2010

(54) PROTECTIVE MASK WITH BREATHABLE FILTERING FACE SEAL

(76) Inventor: Pierre J. Messier, Quebec (CA)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/792,364

(22) Filed: Jun. 2, 2010

Related U.S. Application Data
(63) Continuation-in-part of application No. 10/528,006, filed on Jan. 5, 2006.
(60) Provisional application No. 61/350,002, filed on May 31, 2010.
(60) Provisional application No. 60/411,006, filed on Sep. 16, 2002.
(60) Provisional application No. 60/434,526, filed on Dec. 19, 2002.
(60) Provisional application No. 60/458,800, filed on Mar. 28, 2003.

(51) Int. Cl. A62B 23/02

(52) U.S. Cl. 128/206.19

(57) ABSTRACT

The invention is directed to a protective mask that has high filtration efficiency, yet is easy to breathe through and is comfortable to wear. The mask includes a thin filter body layer configured to cover the mouth and nose of a user when the mask is worn and a thicker compressible gasket positioned along a periphery of the mask. The gasket comprises a high loft, porous dielectric filtering material that forms a breathable closure about the user's face without forming an airtight seal, such that the user can draw breathable air from the sides, top, and bottom of the mask. The mask preferably includes a outer scrim coated with biocidal iodinated resin to provide surface antibacterial properties.

### CROSS-REFERENCE TO RELATED APPLICATIONS

The instant application claims the benefit under 35 U.S.C. 119(e) of U.S. Provisional Patent Application No. 61/350,002, filed May 31, 2010. The instant application is also a continuation-in-part of U.S. patent application Ser. No. 10/528,006, filed Jan. 5, 2006, which is a National Stage Entry under 35 U.S.C. 371 of International (PCT) Patent Application No. PCT/IB03/04543, filed Sep. 8, 2003, which is an application claiming the benefit under 35 U.S.C. 119(e) of U.S. Provisional Patent Application Nos. 60/411,006, filed Sep. 16, 2002, 60/434,526, filed Dec. 19, 2002, and 60/458,800, filed Mar. 28, 2003. The texts of all of the aforementioned patent applications are incorporated herein by reference, in their entirety. All other publications referenced in this document are incorporated herein by reference, in their entirety.

### FIELD OF INVENTION

This invention relates generally to protective masks. More particularly, in certain embodiments, the invention relates to N95 respirators.

### BACKGROUND OF INVENTION

There are a variety of different types of facemasks that are commercially available (as used herein, the terms “mask” and “facemask” are used interchangeably and include, without limitation, face masks, respirators, face shields, surgical masks, filter masks, mouth masks, and gas masks). These facemasks serve various functions which include providing protection from splashes and filtering air-borne contaminants, including pathogens. Facemasks differ substantially in their filtering capacity and their comfort level. Loose fitting facemasks generally provide a significant level of comfort at the expense of filtration ability. As such, these facemasks provide little more than splash protection. On the other hand, facemasks that are designed to have excellent filtering properties do not provide a sufficient level of comfort.

Accordingly, developing a comfortable facemask that has desirable filtration capacity is a long-standing goal. One of the problems facing present filtering facemasks is providing a proper fit to a wide variety of individual wearers such than an airtight seal is maintained about the periphery of the mask, forcing all inhaled air to travel through the filter. There are a wide range of face shapes, and it is therefore difficult to manufacture a facemask that maintains a 100% airtight seal between the skin and the mask for a wide variety of individuals Various different technological means have been tried, such as using adhesive seals, flat and wide seals, and resilient material seals. The function of these seals is to prevent air from penetrating the top, bottom and sides of the mask (i.e., the periphery of the mask). Ideally, all of the breathable air passes through the front of the mask and is filtered, while the periphery of the mask is sealed against the face with a substantially “airtight” seal to prevent breathable air flow there through.

However, in these masks, the pressure differential generated at the periphery of the mask actually forces air into gaps which form from time to time between the seal and skin, thus bypassing the air filter material. Thus, a sufficient quantity of unfiltered air still gets through the top, bottom and sides of the mask. Consider a user wearing an airtight-sealing facemask—the user would experience the pressure differential as a suction holding the mask against the user's face with an airtight seal formed around the edge of the mask. If the mask does not properly fit a given user, the airtight seal may fail to engage and render the user unprotected, since most of the air breathed in will be unfiltered air from the gap in the seal. If the mask fits properly and initially creates an airtight seal, the seal may become compromised by any gap that forms between the user's face and the edge of the mask due to movement of the user's face while wearing the mask. In this case, the pressure differential between the exterior and interior of the mask may actually promote entry of unfiltered air into the mask any time the seal is broken. This unfiltered air is then breathed in by the user, thereby defeating the purpose of the facemask. The problem with maintaining a proper seal is a deficiency recognized by governmental organizations such as OSHA in the U.S., which requires face fitting of protective masks for each individual worker.

Moreover, the airtight seal at the periphery of the mask renders the mask uncomfortable and can make communication difficult. Some wearers complain of a “suction” that causes temporary marks on the face. Also, masks which form an airtight seal against the face generally pose a greater inhalation and exhalation resistance, thereby making breathing more difficult. The airtight sealing masks may also cause the inhaled air to be unpleasantly warm or humid. The majority of advances in the facemask industry have involved attempts to improve the filtering properties of facemasks by creating an improved airtight seal. However, all of these facemasks, to some degree, suffer from the drawbacks described above. Wearer discomfort may result in noncompliance with respirator use rules of a particular establishment.

Given the shortcomings of the prior art, there exists a need for a new facemask that has outstanding filtering capacity and provides a high level of comfort to the wearer. The mask should be able to filter and/or deactivate a large array of microbes and other dangerous contaminants.

### SUMMARY OF INVENTION

The present invention overcomes the aforementioned problems of the prior art. The invention is directed to a protective mask that has high filtration efficiency, yet is easy to breathe through and is comfortable to wear. The mask includes a thin filter body layer configured to cover the mouth and nose of a user when the mask is worn and a thicker compressible gasket positioned along a periphery of the mask. The gasket comprises a high loft, porous dielectric filtering material that forms a breathable seal/closure about the user's face without forming an airtight seal, such that the user can draw breathable air from the sides, top, and bottom of the mask. The mask preferably includes an outer scrim coated with biocidal iodinated resin to provide surface antibacterial properties.

There is no airtight or even semi-airtight seal formed around the periphery of the mask. The user simply breathes in air that freely passes through the high loft breathable dielectric filtering material that forms the compressible gasket around the periphery of the mask and conforms to the user's face. The user also can breathe air directly through the center of the mask (interior to the gasket filter material), which is also filtered. Because there is no airtight seal, there is no excessive pressure difference between the exterior and interior of the mask. The high loft material conforms to the face of the user, and can accommodate a wide variety of face shapes, as well as the movement of faces during use.

The compressible gasket is comprised of a three-dimensional breathable material which is designed to abut the face of a wearer. The compressible gasket does not create an airtight junction but rather is designed to allow breathable air to pass through while providing a sufficient level of comfort to the wearer. The air passing through the compressible gasket is effectively filtered.

In one aspect, the invention is directed to a protective mask for filtering and/or deactivating contaminants in air, the mask including: a filter body comprising a nonwoven filtering substrate, the filter body configured to cover the mouth and nose of a user when the mask is worn; and a compressible non-woven gasket comprising a high loft, porous dielectric filtering material, the gasket positioned along a periphery of the mask, the gasket configured to abut the user's face when the mask is worn, thereby forming a breathable closure without forming an airtight or even a substantially airtight seal between the skin and the mask, such that the user can easily draw breathable air from the sides, top, and bottom of the mask when the mask is worn. The mask is preferably made up of a plurality of stacked layers having the same or substantially equivalent outer dimensions, where the filter body and compressible gasket are two of the stacked layers. The mask is preferably a respirator (e.g., a N95 respirator), however, in certain embodiments, the mask is a face shield, a face mask, a surgical mask, a filter mask, a mouth mask, or a gas mask. In certain embodiments, the mask is a N95 respirator, a N99 respirator, or even a N100 respirator.

In certain embodiments, the mask further comprises an outer cover scrim comprising an active agent, the outer cover scrim forming the outermost layer of the mask and configured to be exposed to the user's environment when the mask is worn. The active agent is preferably a biocidal iodinated resin. In alternative embodiments, the active agent comprises triclosan (a polychloro phenoxy phenol), diatomic halogen, silver, copper, zeolyte with an antimicrobial attached thereto, halogenated resin, or other agent capable of devitalizing/deactivating microorganisms/toxins such as activated carbon, phenol (carbolic acid) compounds, terpenes, other metals, certain acids and bases, and other chemical compounds. It is preferred that the outer cover scrim is coated with the active agent on at least a portion of its outer facing side, such that the active agent prevents surface contamination. In certain embodiments, however, the active agent may be embedded within a matrix of the outer cover scrim and/or may be incorporated in fibers of the outer cover scrim. In preferred embodiments, the filter body is surrounded by the outer cover scrim as well as a face side cover scrim on the opposite side of the filter body. Preferably, the outer cover scrim and face side cover scrim are each between about 0.1 mm and about 0.2 mm in thickness. The outer cover scrim and/or face side cover scrim preferably comprise spunbond media, for example, spunbond polypropylene, polyethylene, polyethylene terephthalate, or other polymer.

In certain embodiments, the filter body comprises a meltblown nonwoven material, and/or the compressible gasket comprises triboelectric media. It is found that the triboelectric compressible gasket can be made of at least two different types of fiber (e.g., polypropylene fiber and modacrylic fiber) such that a long-lasting inherent charge exists and no additional charge need be applied to the gasket to enhance filtration performance. In certain embodiments where self-cleaning of the filter body and/or compressible gasket is desired (e.g., killing of filtered microorganisms such as viruses, mold spores, and bacteria), it is preferred that at least one of the filter body and the compressible gasket comprises a biocidal active agent that kills microorganisms filtered from the air. Use of an iodinated resin as the biocidal active agent shows particular advantages. The active agent may be embedded in the fiber matrix and/or incorporated in the fibers of the filter body and/or the compressible gasket.

The filtering material of the compressible gasket has a high loft and provides a 3D porous structure to sufficiently filter air that is drawn in from the top, bottom, and sides of the mask when in use. The gasket is designed not to cover the mouth and nostrils of the wearer, thereby providing enhanced comfort due to lower inhalation and exhalation resistance, yet the gasket his high enough loft and the airpath therethrough is convoluted and long enough to cause air drawn in from the top, bottom, and sides of the mask to be effectively filtered before being inhaled by the user. The compressible gasket has a desired thickness of at least about 1.5 mm, and more preferably at least about 2.5 mm. In certain embodiments, the compressible gasket has a thickness within a range from about 1 mm to about 10 mm, preferably from about 2 mm to about 5 mm, and more preferably from about 2.5 mm to about 3.5 mm. The filter body has a desired thickness within a range from about 0.1 mm to about 0.3 mm. It is preferred that the filter body be thinner than the compressible gasket to enhance comfort and reduce inhalation and exhalation resistance. In certain embodiments, the filter body is at least about 5 times thinner, or, more preferably, at least about 10 times thinner than the compressible gasket.

In preferred embodiments, the compressible gasket defines an interior opening such that the porous dielectric filtering material of the gasket does not cover the mouth and/or nose of the user when the mask is worn. The gasket is air-permeable along the entire interior opening (e.g., the edge of the interior opening is not sealed at any location), and there is no airtight or semi-airtight seal between the face and the mask at any location. It is desired that the compressible gasket has a width measured from the outer edge to the interior opening in a direction perpendicular to the edge of at least about 1 cm. In certain embodiments, this width is at least about 1.5 cm, or more preferably at least about 2 cm. In preferred embodiments, this width is within a range from about 1.5 cm to about 3 cm, and more preferably from about 2 cm to about 2.5 cm. Given a particular loft and 3-D (convoluted) pore structure, the gasket has a width great enough to provide sufficient filtration of air drawn from the top, bottom, and sides of the mask, accounting for possible partial gaps that may form between the mask and the face of the user. The design of the mask allows for partial gaps to form between the mask and the face of the user, while still providing sufficient filtration of all inhaled air.

The dielectric filtering material of the compressible gasket preferably has a quasi-permanent electrostatic charge. Moreover, the nonwoven filtering substrate of the filter body (e.g., meltblown polypropylene) has a quasi-permanent electrostatic charge.

Because of the unique design of the mask, it is able to achieve outstanding filtration efficiency while maintaining excellent breathability (low inhalation and exhalation resistance). In preferred embodiments, the mask has initial inhalation resistance at 85 l/min of less than 35 mm H₂O and initial exhalation resistance at 85 l/min of less than 25 mm H₂O; more preferably, the mask has initial inhalation resistance at 85 lpm of less than 15 mm H₂O and initial exhalation resistance at 85 l/min of less than 15 mm H₂O; and even more preferably, the mask has mean initial inhalation resistance at 85 lpm of less than 10 mm H₂O and mean initial exhalation resistance at 85 l/min of less than 10 mm H₂O. In preferred embodiments, the differential pressure is less than 5 mm H2O/cm2, and preferably less than 3.5 mm H₂O/cm² (e.g., as measured per ASTM F2100). In addition to the low inhalation and exhalation resistance (less than 35 mm H₂O and 25 mm H₂O respectively), the mask has NaCl penetration at 85 l/min of less than 5.0%, preferably less than 3.0%. More preferably, the mask has a mean NaCl penetration at 85 l/min of less than 2.0%, or even more preferably, less than 1.0%. Values of exhalation resistance, inhalation resistance, and NaCl penetration (0.3 micron NaCl particles) refer to testing performed per NIOSH Procedure #RCT-APR-STP-0057, 0058, and 0059, using TSI 8130 equipment. It is preferred that the mask also have sub-micron particulate filtration efficiency of greater than or equal to 98%, and preferably greater than or equal to 99%, and more preferably greater than or equal to 99.8% (e.g., using 0.1 micron Latex spheres, ASTM F1215). It is also preferable that the mask demonstrate a bacterial filtration efficiency (BFE) of at least 98%, more preferably greater than 99%, and more preferably greater than 99.9% (e.g., Staphylococcus aureus challenge, ASTM F2101). Furthermore, it is preferable that the mask demonstrate a viral filtration efficiency (VFE) of at least 98%, more preferably greater than 99%, and more preferably greater than 99.9% (e.g., PhiX 174 challenge, ASTM F2101 Modified). Example test methods are based on ASTM F2100, Standard Specification for Performance of Materials Used in Medical Face Masks.

For certain embodiments in which the mask contains iodinated resin (e.g., on the surface of the outer cover scrim), it is preferred that the mask demonstrate antimicrobial activity, e.g., a reduction of one or more of the following by at least 99% after a contact time of 15 minutes: Staphylococcus aureus MRSA, Vancomycin-Resistant Enterococcus faecalis (VRE), Escherichia coli, Klebsiella pneumoniae, Influenza A H1N1, and Bacteriophage MS2 Coliphage.

### BRIEF DESCRIPTION OF DRAWINGS

FIG. 1a illustrates a front view of a facemask, according to an illustrative embodiment of the invention.

FIG. 1b illustrates an alternative front view of the facemask of FIG. 1a with the filter body peeled partially away, according to an illustrative embodiment of the invention.

FIG. 2 illustrates a backside view of the facemask, according to an illustrative embodiment of the invention.

FIG. 3 illustrates a back view of the facemask having a differently-shaped compressible gasket, according to an illustrative embodiment of the invention.

FIG. 4 illustrates a facemask when in use, according to an illustrative embodiment of the invention.

FIGS. 5A-C illustrate a backside view, bottom view and a side view, respectively. of a facemask, according to an illustrative embodiment of the invention.

FIG. 6 illustrates a front view of the facemask with outer cover scrim and face side cover scrim, according to an illustrative embodiment of the invention.

FIG. 7 illustrates a front view of the facemask with outer cover scrim, according to an illustrative embodiment of the invention.

### DETAILED DESCRIPTION OF THE INVENTION

The following sections describe exemplary embodiments of the present invention. It should be apparent to those skilled in the art that the described embodiments of the present invention provided herein are illustrative only and not limiting, having been presented by way of example only.

Throughout the description, where items are described as having, including, or comprising one or more specific components, or where processes and methods are described as having, including, or comprising one or more specific steps, it is contemplated that, additionally, there are items of the present invention that consist essentially of, or consist of, the one or more recited components, and that there are processes and methods according to the present invention that consist essentially of, or consist of, the one or more recited processing steps.

The present invention relates generally to a facemask that has outstanding filtering capacity and provides a high-level of comfort to the wearer. The facemask includes a filter body and a compressible gasket attached to the periphery of the filter body. The filter body includes at least one layer of a nonwoven media that is capable of filtering particles. As described below, the filter body may also include an active agent capable of devitalizing microbes and other air-borne contaminants. The compressible gasket is preferably a high loft three-dimensional material that, when in use, is in contact with the face of the wearer. The compressible gasket defines an interior opening such that the high loft, porous dielectric filtering material of the gasket does not cover the mouth and/or nose (nostrils) of the user when the mask is worn. The gasket is air-permeable along the entire interior opening (e.g., the edge of the interior opening is not sealed at any location), and there is no airtight or semi-airtight seal between the face and the mask at any location. The compressible gasket is designed to create a breathable closure that covers all the contours of the different geometrical surfaces of the face. Importantly, the compressible gasket is comprised of a filtering material that is permeable to air. Hence, rather than forming an airtight seal, the compressible gasket allows inhaled or exhaled air to pass through. Any air that passes through the top, bottom or sides of the mask must pass through the compressible gasket, where it is effectively filtered. Moreover, any air passing through the front of the mask will pass through the filter body, where it is filtered.

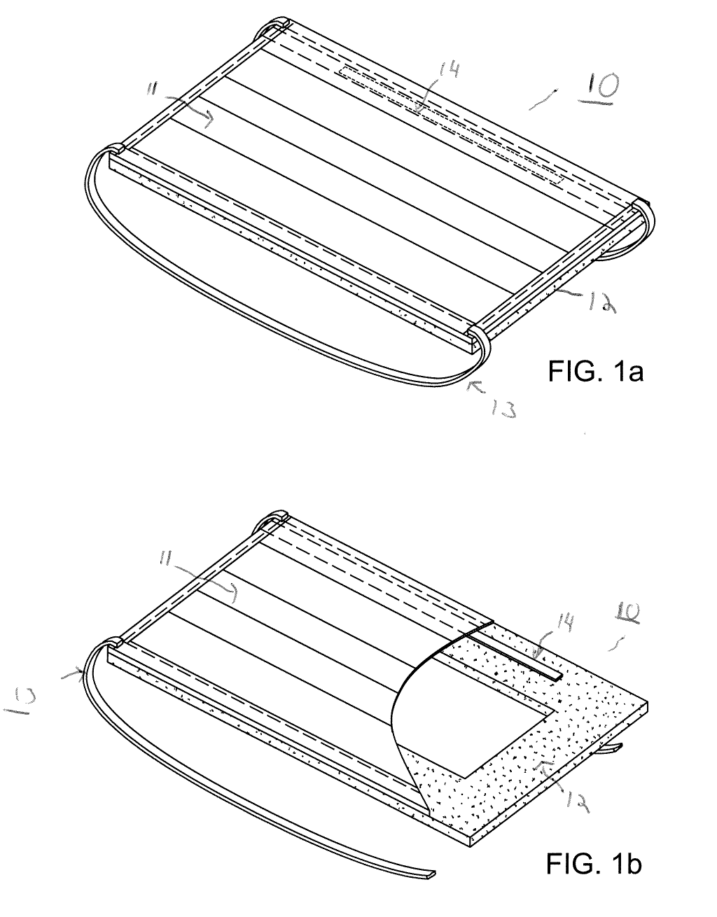

FIGS. 1a and 1b illustrate one embodiment of the facemask of the present invention. These figures show a front view of the facemask. As depicted in FIG. 1a, the facemask 10 includes filter body 11, compressible gasket 12, head straps 13 and flexible nosepiece 14. The dimensions of the facemask may vary and will be dependent on the shape and size of the face of a wearer. Generally, the width of the masks may range from about 13 cm to about 19 cm, more preferably from about 14 cm to about 17.5 cm and most preferably from about 15 cm to about 17 cm. The height of the mask ranges preferably from about 7 cm to about 11 cm, and more preferably from about 8 cm to about 10 cm, and most preferably from about 8.5 cm to about 9.5 cm. In one particularly preferred embodiment, the facemask has dimensions of 15.8 cm×8.5 cm. In another particularly preferred embodiment, the facemask has dimensions of 17 cm×9.5 cm. Because of the unique design of the compressible gasket, the mask need not be customized for an individual wearer. For example, it may be sufficient that only a few sizes (e.g., three or even two) are needed to fit a very wide range of individuals. This eliminates the need to produce many different mask sizes and therefore reduces manufacturing costs.

The filter body 11 is preferably comprised of a substrate, preferably a nonwoven fabric. Nonwoven is a type of fabric that is bonded together rather than being spun and woven into a cloth. It may be a manufactured sheet, mat, web or batt of directionally or randomly oriented fibers bonded by friction or adhesion; it may take the form of a type of fabric. Preferred nonwoven filter media include but are not limited to nylon, polyethylene, polypropylene, polyethylene terephthalate, polyester, etc. or any other polymer suitable for a filter substrate. In such cases, it is preferable that the filter media be prepared from a meltblown process, which provides for optimum filtration performance. Additionally, the filter body 11 can be made of materials other than polymer fiber. For example, the filter body 11 may be made from alternative substrates, which include glass fibers and fibers, such as cellulose, that are ultimately formed into a paper-based filter media. Cellulose fibers may be appropriate where the mask is designed for single use.

The thickness of the filter body may range from about 0.1 mm to 0.25 mm, and more preferably from about 0.13 mm to about 0.19 mm. The density of the filter body 11 preferably ranges from about 20 grams/square meter (gsm) to about 80 gsm, and more preferably from about 30 gsm to about 60 gsm.

In one embodiment, an electrostatic charge is applied to filter body 11, thereby forming an electret. The electrostatic charge enhances the filtration capacity of filter body 11. When a charge is applied, there is a potential across the surface(s) of the filter body 11 creating a field. The field can attract and/or repel charged particles introduced to the media so that in some instances it alters the path of travel of the charged particles. The charge may be induced by using a corona, needle punching, chemical enhancement, any other known charge inducing system or method, or a combination of any of the foregoing. Needle punching creates high-level friction, thus adding a charge. In a particular embodiment, to make the electrostatically charged non-woven fabric the formed media, such as felt, is placed into a corona system of about 25 Kv, slow pass, until fully charged.

It is found that the triboelectric compressible gasket can be made of at least two different types of fiber (e.g., polypropylene fiber and modacrylic fiber) such that a long-lasting inherent charge exists and no additional charge need be applied to the gasket to enhance filtration performance.

In another embodiment, an active agent may be adhered to or incorporated in filter body 11. The active agent of the present invention may be, for example, an antimicrobial, an antitoxin, or the like. The antimicrobial may be biostatic and/or biocidal. Biostatic is a material that inhibits the growth of all or some of bacteria spores, viruses, fungi, etc. (having bioactive particles), and a biocidal is a material that kills all or some of bacteria spores, viruses, fungi, etc. The antimicrobial agent may be applied to a filter body that is electrically charged. The combination of an electret and an active agent provides enhanced filtration capacity.

The prior art teaches against use of antibacterial with electrostatically charged filtration media because of the deleterious effect the antibacterial has on charge over time, thereby reducing filtration efficiency. However, it is surprisingly found that iodinated resin active agent described herein actually preserves the electrostatic charge of the electret media, thereby maintaining its high filtration efficiency. Not only does the iodinated resin pose no deleterious effect on charge, it is observed that the charge stability is actually enhanced by the presence of the iodinated resin.

Thus, a preferred biocidal agent is a demand disinfectant iodinated resin. Iodine/resin demand disinfectants are described, for example, in U.S. Pat. No. 5,639,452 (“the '452 patent”), to Messier, the entire contents of which are hereby incorporated by reference. The '452 patent describes a process for preparing an iodine demand disinfectant resin from an anion exchange resin. The demand disinfectant iodinated resins described in the '452 patent may be ground into a powder. One preferred demand disinfectant iodinated resin is Triosyn® brand iodinated resin powders made by Triosyn Research Inc., a division of Triosyn Corporation of Vermont, USA. The particle sizes of the powders range from about 1 micron to about 150 microns. Preferably, the particle sizes should be in the range from about 4 microns to about 10 microns.

Triosyn® iodinated resin powders used in accordance with the present invention are referred to as Triosyn® T-50 iodinated resin powder, Triosyn® T-45 iodinated resin powder, Triosyn® T-40 iodinated resin powder or Triosyn® T-35 iodinated resin powder. The base polymer used to manufacture such iodinated resins is Amberlite® (Rohm & Haas). These resins contain quaternary ammonium exchange groups with are bonded to styrenedivinyl benzene polymer chains. Other base polymers could be used. The numbers refer to the approximate weight percentage of iodine relative to the resin. Powders with other weight percentages of iodine may also be used in accordance with the present invention. Different percentages of iodine in the iodinated resin powders will confer different properties to the powder, in particular, different levels of biocidal activity. The particular resin used is based on the desired application. It is important to note that iodinated resin from other sources can also be used.

The Triosyn® iodinated resin may be adhered to the surface of filter body 11. For instance, a mix of adhesive (e.g., glue) and water may be sprayed on the filter body 11 followed by drying. Next, a solution of water and Triosyn® iodinated resin powder are sprayed onto the surface of filter body 11. After drying, the iodinated resin powder adheres to the filter body 11. In an alternative embodiment, the iodinated resin may be physically entrapped within the interstitial matrix of the nonwoven fibers. Methods of physically entrapping iodinated resin particulates in a nonwoven matrix are described in U.S. Patent Application No. 2006/0251879, which is hereby incorporated by reference. In another alternative embodiment, the iodinated resin may be embedded within the fibers comprising the nonwoven material. Methods of embedding iodinated resin in fibers comprising a nonwoven matrix is described in U.S. Patent Application No. 2009/0259158, which is hereby incorporated by reference.

Other active agents that may be used in addition to—or, in alternative embodiments, instead of—the iodinated resin include, but are not limited to, triclosan (a polychloro phenoxy phenol), diatomic halogen, silver, copper, zeolyte with an antimicrobial attached thereto, halogenated resin, or other agent capable of devitalizing/deactivating microorganisms/toxins such as activated carbon, phenol (carbolic acid) compounds, terpenes, other metals, certain acids and bases, and other chemical compounds.

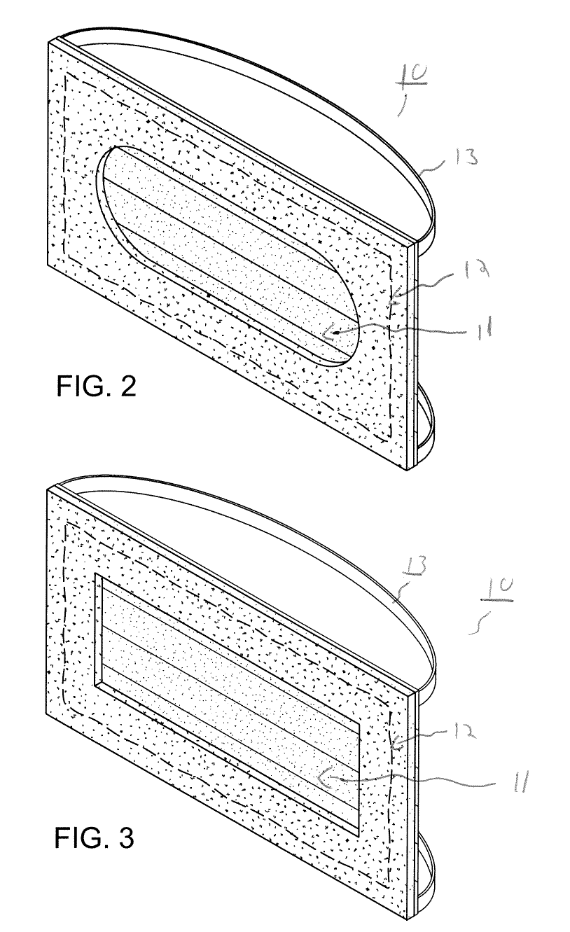

Returning to FIG. 1a, the filter body 11 of facemask 10 is attached to compressible gasket 12. The compressible gasket 12 is attached at the periphery of the filter body 11 and extends from the outer edge of the mask into the interior of the mask, defining an opening in the interior large enough to accommodate the mouth and nostrils of the user (exemplary openings can be seen in FIGS. 1b, 2, and 3). The gasket 12 may be attached to the filter body 11 by various means. For instance, in one embodiment, the gasket 12 and filter body 11 are ultrasonically welded. Alternatively, the two layers may be attached to each other by stitching and/or adhesive. The outer perimeter of the gasket 12 and/or filter body 11 may be sealed (e.g., ultrasonically sealed) to protect the interior of these layers, but it should be made clear that this is not intended to create any airtight or semi-airtight seal between the mask and skin at any given location. The compressible gasket 12 can be seen clearly in FIG. 1b, where a portion of filter body 12 is partially peeled away for clarification purposes. Additionally, a backside view of facemask 10 is depicted in FIG. 2. A backside view of a facemask of the present invention with an alternative configuration is illustrated in FIG. 3. It is noted that different configurations of the facemask are made to accommodate different face sizes and shapes. The relative orientation of the compressible gasket 12 with respect to filter body 11 can clearly be seen in FIGS. 2 and 3.

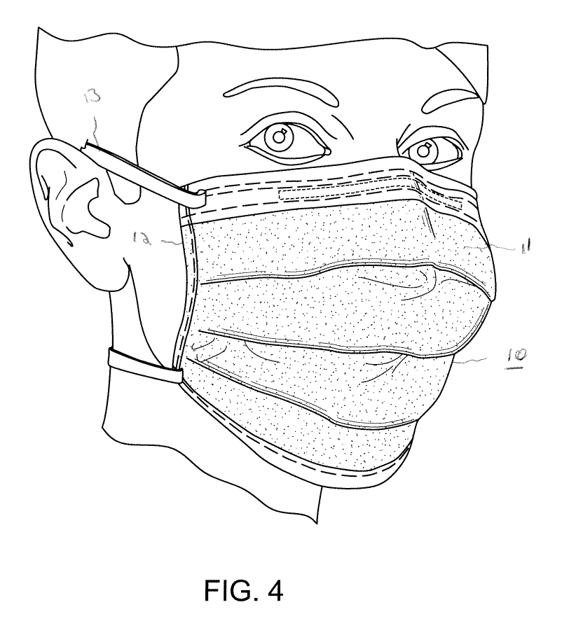

As illustrated in FIGS. 1b, 2 and 3, while the compressible gasket 12 occupies the entirety of the periphery of the facemask, it extends only partially into the interior of the mask. The width of the gasket 12 (measured from the outer edge in a direction perpendicular to the edge and toward the center of the mask) is in the range of about 1.0-5.0 cm, more preferably from about 1.5-3.0 cm and most preferably from about 2.0-2.5 cm. The thickness of the gasket is in the range of about 1 mm to 10 mm, and preferably in the range of about 2 mm to about 5 mm, and most preferably in the range of about 2.5 mm to 3.5 mm. In use (FIG. 4), the compressible gasket 12 comfortably abuts the face of the wearer. Additionally, the use of head straps 13 to hold the mask in place to compresses the gasket of the present invention to fit essentially all faces. The filter body 11 occupies the space around the nose and mouth.

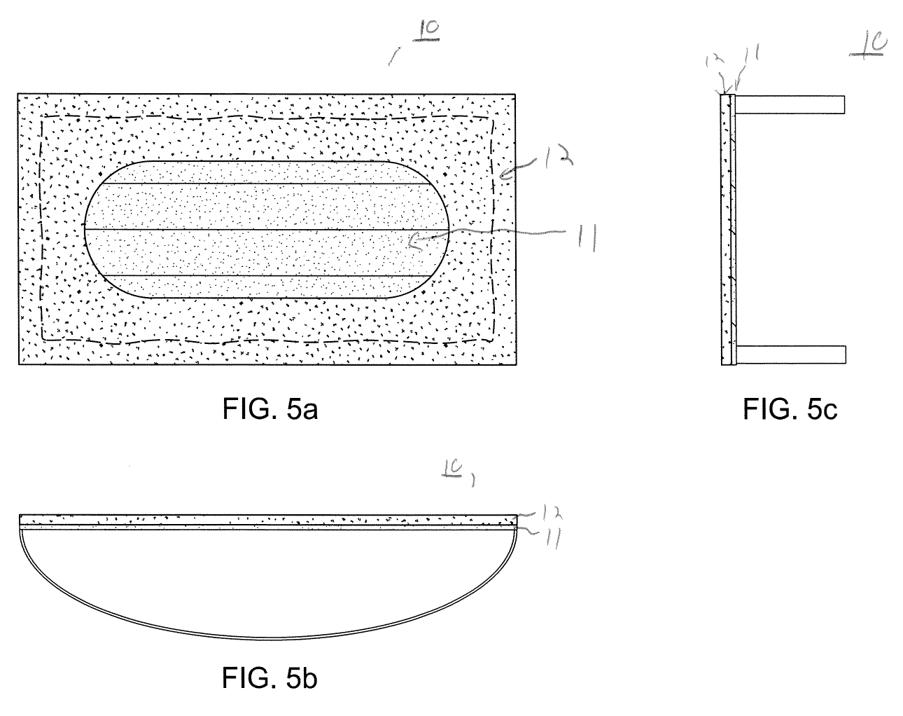

FIGS. 5a-c show a backside view bottom view and a side view, respectively, of a facemask of the present invention. In can be appreciated from FIGS. 5b and 5c that the compressible gasket 12 of facemask 10 is considerably thicker than the filtering body 13. The compressible gasket 12 is comprised of a breathable material that provides enhanced comfort to the wearer. Additionally, the compressible gasket 12 is capable of filtering any air passing through the top, bottom and sides of the mask. To achieve this, the filtering material is preferably made of a nonwoven media. Preferably, the compressible gasket 12 holds an electrostatic charge. The electrical charge enhances the filtration efficiency of the nonwoven media. A preferred example of a filtration media used to make the compressible gasket is a triboelectric media. In the process of triboelectrification, electric charge is transferred between different pieces of different polymeric materials by contact or by friction. The product obtained by such contact of polymeric materials is referred to as a triboelectric media. Preferably, the triboelectric media is comprised of a high loft material with a density in the range preferably from about 150 gsm to about 600 gsm, or from about 200 gsm to about 400 gsm, or more preferably in the range from about 250 gsm to about 300 gsm. A particularly preferred triboelectric media used in accordance with the present invention is comprised of polypropylene fibers and modacrylic fibers. It is found that where the triboelectric compressible gasket is made of both polypropylene fiber and modacrylic fiber, a long-lasting inherent charge exists and no additional charge need be applied to the gasket to enhance filtration performance. As will be described in the Examples below, the combination of the filter body 11 and the compressible gasket 12 provides the facemask with a filtration capacity needed to have at least a N95 NIOSH rating, and in some cases may provide masks with a N99 or N100 rating.

Additionally, as with the filter body 10, compressible gasket 12 may contain an active agent. The active agent may include but is not limited to an iodinated resin triclosan, diatomic halogens, silver, copper, zeolyte with an antimicrobial attached thereto, halogenated resins, and agents capable of devitalizing/deactivating microorganisms/toxins that are known in the art, including for example activated carbon, other metals and other chemical compounds. In one embodiment, both an active agent and an electrical charge can be applied to the filter media.

As discussed above, compressible gasket 12 serves several important functions. The compressible gasket 12 significantly reduces exposure to airborne particles which enter the mask from the top, sides and bottom. Because the gasket is not designed to form an airtight seal, as with prior art facemasks, air is not forced through holes generated from an imperfect fit. Instead, air is allowed to through the compressible gasket 12, where it is effectively filtered. Accordingly, both the filter body 11 and the compressible gasket 12 are responsible for the outstanding filtration properties of the mask. Moreover, the compressible gasket 12 is made from a breathable material and hence, has a low pressure drop across the media. The low pressure drop translates do a high level of comfort, contrary to masks that are designed to form an airtight seal at the periphery. Besides providing comfort, the facemasks of the present invention allow the wearer to communicate effectively, which is quite contrary to masks designed with an airtight seal. The ability to communicate effectively and comprehensibly while wearing a facemask is particularly important in the medical profession.

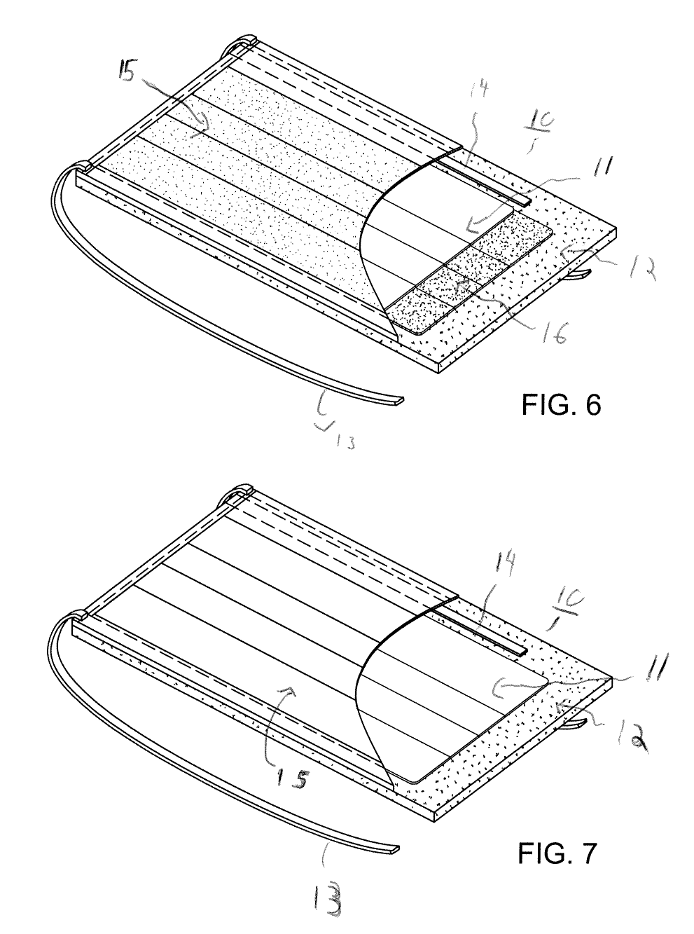

Another embodiment of the facemask of the present invention is illustrated in FIG. 6. The facemask 10 includes four distinct layers, a filter body 11, compressible gasket 12, an outer cover scrim 15 and a face side cover scrim 16. The outer cover scrim 15 and a face side cover scrim 16 surround filter body 11. The individual layers are shown as partially peeled away for clarity purposes. Facemask 10 also contains straps 13 and flexible nosepiece 14. In alternative embodiments, the facemask 10 may include either an outer scrim 15 or a face side cover scrim 16. The embodiment with a facemask having just the outer scrim 15 is illustrated in FIG. 7. Typical densities of the outer scrim 15 and face side cover scrim 16 range from about 20 gsm to about 80 gsm, and more preferably from about 30 gsm to about 40 gsm. The thickness of both scrims range from about 0.1 mm to about 0.3 mm. Suitable materials for the scrims include but are not limited to polypropylene, polyethylene, nylon, and polyester The scrims are preferably made from a spunbond media. Most preferably, the outer scrim 15 and face side cover scrim 16 are comprised of thermal bond polypropylene. Both the outer cover scrim 15 and face side cover scrim 16 provide the facemask 10 with additional bulk and offer an extra layer of protection. In addition, the scrim(s) may be composed of fibers with greater strength than fibers of the filter body, thereby adding strength to the overall mask and preventing premature degradation of the filter body 11. The scrim(s) may also provide better adherence and stability of applied active agent, e.g., iodinated resin, than would be provided by the filter body alone, and without affecting the filtering properties of the filter body. When face side cover scrim 16 is present in the facemask 10, it rests against the nose and mouth of the wearer and provides additional comfort.

Outer cover scrim 15 may contain an active agent. Preferred active agents include but are not limited to iodinated resin, triclosan, diatomic halogens, silver, copper, zeolyte with an antimicrobial attached thereto, halogenated resins, and agents capable of devitalizing/deactivating microorganisms/toxins that are known in the art, including for example activated carbon, other metals and other chemical compounds. It has been found that adding an iodinated resin to outer cover scrim 15 is particularly effective against a host of different microorganisms. In a preferred embodiment, the iodinated resin is adhered to the scrim using a suitable adhesive. The surface concentration of iodinated resin is preferably within the range from about 1 g/m² to about 15 g/m², or within the range from about 1 g/m² to about 3.5 g/m², for example, about 2 g/m². The iodinated resin may be, for example, Triosyn® T-50 iodinated resin powder, Triosyn® T-45 iodinated resin powder, Triosyn® T-40 iodinated resin powder or Triosyn® T-35 iodinated resin powder. In one specific example, the iodinated resin has an average particle size of about 10 micron, although other particle sizes may be used. The adhesive used may be, for example, a water-based adhesive such as Simalfa® adhesive (e.g., made from acrylates copolymer and rubber latex), or the like, in an amount within the range from about 1 g/m² to about 3.5 g/m², for example, about 4 g/m².

Since the outer cover scrim 15 is preferably a spunbond nonwoven material, the iodinated resin can be adhered to the nonwoven media without affecting the properties of the filter body 11. For instance, a mix of adhesive (e.g., glue) and water may be sprayed on the outer cover scrim 15 followed by drying. Next, a solution of water and Triosyn® iodinated resin powder are sprayed onto the surface of outer cover scrim 15. After drying, the iodinated resin powder adheres to the outer cover scrim 15. Alternatively, the iodinated resin may be embedded within the three-dimensional matrix of outer scrim 15. When the active agent (e.g., iodinated resin) is present in the outer cover scrim 15, the surface of the facemask is rendered toxic to a large away of different microbes and other contaminants. Contamination of a mask surface may occur, for example, due to a splash of body fluids such as blood or sputum (e.g., in a surgical, dental, or medical procedure setting), or by the touching of the mask by the wearer with contaminated fingers or gloves. In these cases, the microbes first come into contact with outer cover scrim 15, and they will be deactivated on contact with the active agent. As discussed with respect to FIG. 1, additional active agent may be incorporated into filter body 11 to provide an additional level of protection against microbes and other contaminants. Because the outer cover scrim 15 and face side cover scrim 16 are thin and highly air-permeable, they do not pose a significant pressure drop and do not appreciably increase inhalation or exhalation resistance.

When coupled with the outstanding filtration properties of the facemask of the present invention, the presence of a thin outer layer (e.g., scrim) containing an active agent (e.g., iodinated resin) provides the inventive facemasks with multiple levels of protection. The masks are comfortable to wear and could be produced at relatively low costs. Additionally, the masks are biocompatible and nontoxic to the wearer.

### EXPERIMENTAL EXAMPLES

Facemasks prepared in accordance with embodiments of the present invention were tested for filtration efficiency, inhalation and exhalation resistance and microbiological performance. The facemasks tested contained a meltblown polypropylene filter body and a compressible gasket comprised of a triboelectric polypropylene media. In addition, the facemasks contained an outer cover scrim and a face side cover scrim made of spunbond polypropylene. The face side cover scrim contained Triosyn® T-50 iodinated resin powder adhered to its surface.

### Filtration Efficiency

We determined whether facemasks produced in accordance with the present invention are N95 respirators. A filtering facepiece respirator that filters out at least 95% of airborne particles during “worse case” testing using a “most-penetrating” sized particle is given a 95 rating. There are nine classes of NIOSH-approved particulate filtering respirators available at this time. 95% is the minimal level of filtration that will be approved by NIOSH. The N, R and P designations refer to the filter's oil resistance: N filters are not resistant to oil, R filters are somewhat resistant to oil, and P filters are strongly resistant to oil. Testing protocols improved with gaining N95 approval are well-known (see, for instance, S. Rengasamy, W. P. King, B. C. Eimer and R. E. Shaffer (2008). Filtration performance of NIOSH-approved N95 and P100 filtering facepiece respirators against 4 to 30 nanometer-size nanoparticles. Journal of Occupational and Environmental Hygiene 5(9):556-564, which is hereby incorporated by reference).

To determine the filtration efficiency of the facemasks of the present invention, we used an NaCl penetration test. In the NaCl penetration test, an aerosol containing 0.3 micron NaCl particles is flowed through the mask at a flow rate of 85 L/min. The testing was performed per NIOSH Procedure #RCT-APR-STP-0057, 0058, and 0059. The TSI Automated Filter Tester 8130 was used to generate the data.

Two series of masks were tested. One series of masks are characterized as small/medium (S/M). The S/M masks have dimensions of 15.8×8.5 cm. The S/M masks have a meltblown polypropylene filter body 11 with 0.19 mm thickness, a triboelectric polypropylene compressible gasket 12 with 2.69 mm thickness, a polypropylene outer cover scrim 15 with 0.16 mm thickness, and a thermal bond polypropylene face side cover scrim 16 with 0.10 mm thickness.

The other series of masks are characterized as medium/large (M/L). The M/L masks have dimensions of 17 cm×9.5 cm. The M/L masks have a meltblown polypropylene filter body 11 with 0.13 mm thickness, a triboelectric polypropylene compressible gasket 12 with 2.69 mm thickness, a polypropylene outer cover scrim 15 with 0.19 mm thickness, and a thermal bond polypropylene face side cover scrim 16 with 0.10 mm thickness.

Twenty individual masks from each series were tested. The results from the S/M series are shown in are shown in Table 1 and the results from the M/L series are shown in Table 2.

TABLE 1
Measure of Filtration Efficiency of the S/M
Series of Inventive Facemasks

| | NaCl penetration |
|---|---|
| | At 85 l/min |
| Sample | (5.00% max) |
| 1 | 0.960 |
| 2 | 1.32 |
| 3 | 1.21 |
| 4 | 0.702 |
| 5 | 1.38 |
| 6 | 2.02 |
| 7 | 1.14 |
| 8 | 1.38 |
| 9 | 0.851 |
| 10 | 1.15 |
| 11 | 2.43 |
| 12 | 1.42 |
| 13 | 2.23 |
| 14 | 2.25 |
| 15 | 2.52 |
| 16 | 1.59 |
| 17 | 1.22 |
| 18 | 2.33 |
| 19 | 2.70 |
| 20 | 1.69 |
| Mean | 1.62 |
| Std Dev | 0.605 |

TABLE 2
Measure of Filtration Efficiency of the M/L
Series of Inventive Facemasks

| | NaCl penetration |
|---|---|
| | At 85 l/min |
| Sample | (5.00% max) |
| 1 | 0.281 |
| 2 | 0.529 |
| 3 | 0.999 |
| 4 | 0.498 |
| 5 | 0.459 |
| 6 | 0.466 |
| 7 | 0.536 |
| 8 | 0.873 |
| 9 | 0.578 |
| 10 | 0.462 |
| 11 | 0.641 |
| 12 | 0.392 |
| 13 | 0.886 |
| 14 | 0.285 |
| 15 | 0.143 |
| 16 | 0.469 |
| 17 | 0.202 |
| 18 | 0.289 |
| 19 | 0.273 |
| 20 | 0.310 |
| Mean | 0.479 |
| Std Dev | 0.231 |

As shown in Table 1 for the S/M series of facemasks, on average, less than 2.0% of the NaCl particles penetrated the facemasks. As shown in Table 2 for the M/L series, less than 1.0% of the NaCl particles penetrated the facemasks. Hence, the inventive masks demonstrate the filtration performance of at least N95 respirators, where a maximum of 5.0% of NaCl penetration is permitted.

### Inhalation and Exhalation Resistance

Tests were also conducted to determine inhalation and exhalation resistance of the inventive facemasks. The tests performed were based on ASTM F2100-Standard Specification For Performance of Materials Used In Medical face Masks. A value of 35 mm H₂O (pressure) or greater indicates that resistance to inhalation is not acceptable. A value of 25 mm H₂O (pressure) or greater indicates that resistance to exhalation is not acceptable. Results of inhalation and exhalation resistance testing for the S/M series of facemasks of the present invention are shown in Table 3. Results of inhalation and exhalation resistance testing for the M/L series of facemasks of the present invention are shown in Table 4.

TABLE 3
Measure of Inhalation and Exhalation Resistance of the
S/M Series of Inventive facemasks

| | Initial Inhalation | Initial Exhalation |
|---|---|---|
| | resistance at 85 L/min | resistance at 85 L/min |
| Sample | (mm water column) | (mm water column) |
| 1 | 8.5 | 8.4 |
| 2 | 9.0 | 8.8 |
| 3 | 8.9 | 8.7 |
| 4 | 9.6 | 9.4 |
| 5 | 10.0 | 9.8 |
| 6 | 8.6 | 8.4 |
| 7 | 8.8 | |
| 8 | 8.3 | |
| 9 | 9.8 | |
| 10 | 8.6 | |
| 11 | 8.9 | |
| 12 | 8.7 | |
| 13 | 10.1 | |
| 14 | 9.1 | |
| 15 | 9.5 | |
| 16 | 8.6 | |
| 17 | 8.6 | |
| 18 | 9.5 | |
| 19 | 8.8 | |
| 20 | 8.9 | |
| Mean | 9.0 | 8.9 |
| Std Dev | 0.527 | 0.567 |

TABLE 4
Measure of Inhalation and Exhalation Resistance of the
M/L Series of Inventive facemasks

| | Initial Inhalation | Initial Exhalation |
|---|---|---|
| | resistance at 85 L/min | resistance at 85 L/min |
| Sample | (mm water column) | (mm water column) |
| 1 | 8.8 | 8.5 |
| 2 | 7.9 | 7.7 |
| 3 | 8.3 | 7.8 |
| 4 | 7.7 | 7.5 |
| 5 | 8.3 | 7.9 |
| 6 | 8.1 | 8.0 |
| 7 | 8.0 | |
| 8 | 8.3 | |
| 9 | 7.9 | |
| 10 | 8.4 | |
| 11 | 8.1 | |
| 12 | 7.8 | |
| 13 | 8.1 | |
| 14 | 8.4 | |
| 15 | 9.3 | |
| 16 | 8.1 | |
| 17 | 8.8 | |
| 18 | 8.6 | |
| 19 | 8.5 | |
| 20 | 8.3 | |
| Mean | 8.3 | 7.9 |
| Std Dev | 0.385 | 0.341 |

As shown in Tables 3 and 4, the mean initial inhalation resistance for the S/M series of inventive facemasks is 9.0 mm H₂O and the mean initial exhalation resistance is 8.9 mm H₂O. For the M/L series of inventive facemasks, the mean initial inhalation resistance is 8.3 mm H₂O and the mean initial exhalation resistance is 7.9 mm H₂O, Notably, these values fall well below the acceptable maximum. Hence, the inventive masks not only provide a very high level of filtration efficiency but are easy to breathe through.

### Sub-Micron Particulate, Bacterial, and Viral Filtration Efficiency

In addition to the NaCl testing above, the aforementioned inventive facemasks were tested for sub-micron particulate filtration efficiency, bacterial filtration efficiency, and viral filtration efficiency, with results shown in Table 5.

TABLE 5
Measure of Sub-micron Particulate, Bacterial, and Viral
Filtration Efficiencies of Inventive facemasks

| | | | Specification |
|---|---|---|---|
| Test/Standard | Challenge Used | Results | Requirements |
| NIOSH N-Series Filters/42 | 0.3 micron NaCl | 98.8% | ≧95% |
| CFR Part 84 | particles | | (NIOSH |
| | | | N95 Rating) |
| Sub-micron Particulate | 0.1 micron Latex | 99.88% | ≧98% |
| Filtration Efficiency/ | spheres | | |
| ASTM F1215 | | | |
| Bacterial Filtration | Staphylococcus | >99.9% | ≧98% |
| Efficiency (BFE)/ASTM | aureus | | |
| F2101 | | | |
| Viral Filtration Efficiency | PhiX 174 | >99.9% | — |
| (VFE)/ASTM F2101 | | | |
| Modified | | | |

The sub-micron particulate filtration efficiency of the masks is greater than 99.8% using 0.1 micron Latex spheres according to the ASTM F1215 test procedure. Furthermore, the bacterial filtration efficiency (BFE) of the masks is greater than 99.9% using the Staphylococcus aureus challenge according to the ASTM F2101 test procedure. Moreover, the viral filtration efficiency (VFE) of the masks is greater than 99.9% using the PhiX 174 challenge according to the ASTM F2101 Modified test procedure. Test methods are based on ASTM F2100, Standard Specification for Performance of Materials Used in Medical Face Masks.

These results show that the masks not only meet but clearly exceed NIOSH N95 rating requirements for filtration of sub-micron particulate, bacteria, and viruses.

### Antimicrobial Properties of Triosyn-Coated Spunbond Polypropylene Outer Scrim

Testing was performed to demonstrate the biocidal properties of the above-described spunbond polypropylene outer cover scrim 15 of the inventive facemasks upon coating with iodinated resin.

For purposes of the tests, 1 inch×1 inch pieces of the outer cover scrim material were coated with Triosyn® T-50 iodinated resin powder such that the surface concentration of iodinated resin was 2 g/m². The water-based adhesive, Simalfa® (e.g., made from acrylates copolymer and rubber latex), was used at a concentration of about 4 g/m². The Triosyn-treated samples were compared against non-treated 1 inch×1 inch samples of the scrim material. Both treated and non-treated samples were exposed to 100 μL liquid microbial suspension for a 15 minute contact time, then the samples were placed in neutralizing fluid to recover viable microorganisms. The viable microorganisms were then counted (CFU). Test methods used were (i) the AATCC Test Method 100-2004: Assessment of Antibacterial Finishes on Textile Materials; and (ii) Protocol No. PRT-M-0035: Surface Antimicrobial Activity Protocol: liquid Innoculum with cover slip.

The test results are shown in Tables 6-11 below.

TABLE 6
Antimicrobial Activity of Triosyn-coated Spunbond Polypropylene
Outer Scrim - Staphylococcus aureus MRSA Test

| | Blank Control | Triosyn-coated |
|---|---|---|
| Contact Time | (CFU Total) | (% Reduction) |
| 0 min | 1.73E+06 | N/A |
| 15 min | 1.47E+06 | >99% |

Detection level = 50 CFU
Samples tested n = 9

TABLE 7
Antimicrobial Activity of Triosyn-coated Spunbond Polypropylene
Outer Scrim - Vancomycin-Resistant Enterococcus faecalis (VRE)

| | Blank Control | Triosyn-coated |
|---|---|---|
| Contact Time | (CFU Total) | (% Reduction) |
| 0 min | 1.62E+06 | N/A |
| 15 min | 1.83E+06 | >99% |

Detection level = 50 CFU
Samples tested n = 9

TABLE 8
Antimicrobial Activity of Triosyn-coated Spunbond Polypropylene
Outer Scrim - Escherichia coli

| | Blank Control | Triosyn-coated |
|---|---|---|
| Contact Time | (CFU Total) | (% Reduction) |
| 0 min | 5.47E+06 | N/A |
| 15 min | 6.40E+06 | >99% |

Detection level = 50 CFU
Samples tested n = 9

TABLE 9
Antimicrobial Activity of Triosyn-coated Spunbond Polypropylene
Outer Scrim - Klebsiella pneumoniae

| | Blank Control | Triosyn-coated |
|---|---|---|
| Contact Time | (CFU Total) | (% Reduction) |
| 0 min | 5.72E+06 | N/A |
| 15 min | 5.12E+06 | >99% |

Detection level = 50 CFU
Samples tested n = 9

TABLE 10
Antimicrobial Activity of Triosyn-coated Spunbond Polypropylene
Outer Scrim - Influenza A H1N1

| | Blank Control | Triosyn-coated |
|---|---|---|
| Contact Time | (PFU Total) | (% Reduction) |
| 0 min | 3.38E+06 | N/A |
| 15 min | 1.38E+06 | >99% |

Detection level = 5.56 PFU
Samples tested n = 18

TABLE 11
Antimicrobial Activity of Triosyn-coated Spunbond Polypropylene
Outer Scrim - Bacteriophage MS2 Coliphage

| | Blank Control | Triosyn-coated |
|---|---|---|
| Contact Time | (CFU Total) | (% Reduction) |
| 0 min | 1.95E+06 | N/A |
| 15 min | 1.33E+06 | >99% |

Detection level = 50 CFR
Samples tested n = 9

Thus, the iodinated-resin-coated, spunbond polypropylene outer cover scrim 15 of the inventive facemasks demonstrate a reduction of each of the following by at least 99% after a contact time of 15 minutes: Staphylococcus aureus MRSA, Vancomycin-Resistant Enterococcus faecalis (VRE), Escherichia coli, Klebsiella pneumoniae, Influenza A H1N1, and Bacteriophage MS2 Coliphage.

While the invention has been particularly shown and described with reference to specific preferred embodiments, it should be understood by those skilled in the art that various changes in form and detail may be made therein without departing from the spirit and scope of the invention as defined by the appended claims. Insofar as this is a provisional application, what is considered applicants' invention is not necessarily limited to embodiments that fall within the scope of the claims below.

What is claimed is:

1. A protective mask for filtering and/or deactivating contaminants in air, the mask comprising:
a filter body comprising a nonwoven filtering substrate, the filter body configured to cover the mouth and nose of a user when the mask is worn; and
a compressible gasket comprising a high loft, porous dielectric filtering material, the gasket positioned along a periphery of the mask, the gasket configured to abut the user's face when the mask is worn, thereby forming a breathable closure without forming an airtight or substantially airtight seal, such that the user can draw breathable air from the sides, top, and bottom of the mask when the mask is worn.

2. The mask of claim 1, further comprising an outer cover scrim comprising an active agent, the outer cover scrim forming the outermost layer of the mask and configured to be exposed to the user's environment when the mask is worn.

3. The mask of claim 2, wherein the active agent comprises a biocidal iodinated resin.

4. The mask of claim 1, wherein the mask comprises a plurality of stacked layers and the filter body and compressible gasket have substantially equivalent outer dimensions and are two of the stacked layers of the mask.

5. The mask of claim 2, wherein the outer cover scrim is coated with the active agent on at least a portion of its outer facing side, and the active agent prevents surface contamination.

6. The mask of claim 2, wherein the active agent is embedded within a matrix of the outer cover scrim and/or is incorporated in fibers of the outer cover scrim.

7. The mask of claim 2, further comprising a face side cover scrim, wherein the filter body is surrounded by the outer cover scrim and the face side cover scrim.

8. The mask of claim 7, wherein the outer cover scrim and face side cover scrim are each between about 0.1 and about 0.2 mm in thickness.

9. The mask of claim 7, wherein the outer cover scrim and/or face side cover scrim comprises spunbond media.

10. The mask of claim 1, wherein the filter body comprises a meltblown nonwoven material.

11. The mask of claim 1, wherein the compressible gasket comprises triboelectric media.

12. The mask of claim 11, wherein the compressible gasket comprises at least two different types of fiber which create an inherent charge [no additional charge needs to be applied].

13. The mask of claim 11, wherein the compressible gasket comprises polypropylene fiber and modacrylic fiber.

14. The mask of claim 1, wherein at least one of the filter body and the compressible gasket comprises a biocidal active agent that kills microorganisms filtered from the air.

15. The mask of claim 14, wherein the biocidal active agent comprises iodinated resin.

16. The mask of claim 14, wherein the active agent is embedded in the fiber matrix and/or incorporated in the fibers of at least one of the filter body and the compressible gasket.

17. The mask of claim 1, wherein the compressible gasket is at least about 1.5 mm thick.

18. The mask of claim 1, wherein the compressible gasket is at least about 2.5 mm thick.

19. The mask of claim 1, wherein the compressible gasket has a thickness within a range from about 2 mm to about 5 mm.

20. The mask of claim 1, wherein the filter body has a thickness within a range from about 0.1 mm to about 0.3 mm.

21. The mask of claim 1, wherein the compressible gasket defines an interior opening such that the porous dielectric filtering material of the gasket does not cover the mouth and/or nose of the user when the mask is worn.

22. The mask of claim 21, wherein the compressible gasket has a width measured from the outer edge to the interior opening in a direction perpendicular to the edge of at least 1 cm.

23. The mask of claim 21, wherein the dielectric filtering material of the compressible gasket has a quasi-permanent electric charge.

24. The mask of claim 1, wherein the nonwoven filtering substrate of the filter body has a quasi-permanent electric charge.

25. The mask of claim 1, wherein the mask is a N95 respirator.

26. The mask of claim 1, wherein the mask is a member selected from the group consisting of a respirator, a face shield, a face mask, a surgical mask, a filter mask, a mouth mask, and a gas mask.

27. The mask of claim 1, wherein the mask has initial inhalation resistance at 85 l/min less than 35 mm H₂O and initial exhalation resistance at 85 l/min less than 25 mm H₂O.

28. The mask of claim 27, wherein the mask has initial inhalation resistance at 85 lpm less than 15 mm H₂O and initial exhalation resistance at 85 l/min less than 15 mm H₂O.

29. The mask of claim 27, wherein the mask has NaCl penetration at 85 l/min less than 5.0%.

30. The mask of claim 29, wherein the mask has NaCl penetration at 85 l/min less than 3.0%.
